(19) United States
(12) Patent Application Publication
(10) Pub. No.: US 2024/0029123 A1
(43) Pub. Date: Jan. 25, 2024

(54) B2B-BASED CLOUD DISTRIBUTION PLATFORM SYSTEM

(71) Applicant: HAINAN CLOUD INFORMATION TECHNOLOGY CO., LTD., Haikou City (CN)

(72) Inventors: Ruifeng Wang, Haikou City (CN); Zhiyong Wu, Haikou City (CN)

(21) Appl. No.: 17/297,239

(22) PCT Filed: May 17, 2021
(86) PCT No.: PCT/CN2021/094007

§ 371 Date: May 26, 2021

(30) Foreign Application Priority Data
Apr. 13, 2021 (CN) 2021110395831.3

(51) Int. Cl. G06Q 30/04; G06Q 20/38; G06Q 20/40; G06Q 20/10

(52) U.S. Cl. CPC G06Q 30/04; G06Q 20/3829; G06Q 20/4014; G06Q 20/102

(57) ABSTRACT

A B2B-based cloud distribution platform system, which comprises a client end and a server end, wherein the server end comprises: a business module, which is used to display and provide the client end with the business and business fee information that the distribution platform can provide, and at the same time accept the order information of the customer; operation module, connected with business module, used to receive order information and generate bills; the feedback module, which is connected with the operation module and the client end, is used to feedback the billing information generated by the operation module to the client end for the customer's confirmation; The financial operation node, which is connected with the feedback module and the operation module to deduct the payment according to the billing information generated by the operation module, and feedback the payment success information to the client end through the feedback module. The B2B-based cloud distribution platform system provided by the invention is especially suitable for tourism product providers, which can save the program development cost of enterprises, protect the privacy of users and the security of funds

### TECHNICAL FIELD

The invention relates to the technical field of the Internet of Things, in particular to a B2B-based cloud distribution platform system.

### BACKGROUND

The rapid development of the Internet of Things industry makes many businesses focus on online marketing, compared with traditional online marketing models, online marketing has the advantages of transparent information and efficient query. However, the many drawbacks of the Internet of Things also make the online marketing model have many shortcomings, the most obvious drawback is that the existing major e-marketing platforms do not fully take into account the security of customers' transaction funds and personal privacy, which brings troubles to customers' lives.

### SUMMARY OF THE INVENTION

In order to solve the shortcomings of the existing technology, the present invention provides a B2B-based cloud distribution platform system, comprising a client end and a server end, in which:
the server end comprises:
a business module, which is used to display and provide the client end with the business and business fee information that the distribution platform can provide, and at the same time accept the order information of the customer;
a operation module, which is connected with business module, used to receive order information and generate bills;
a feedback module, which is connected with the operation module and the client, is used to feedback the billing information generated by the operation module to the client end for the customer's confirmation;
a financial operation node, which is connected with the feedback module and the operation module to deduct the payment according to the billing information generated by the operation module, and feedback the payment success information to the client end through the feedback module,
wherein the server end also comprises a rule engine module and a data encapsulation module, the rule engine module is connected with the operation module to provide the operation module with target billing rules for the operation module to generate billing information;
the data encapsulation module is connected with the business module and the operation module, and is used to accept the user order information provided by the business module, and convert the corresponding data format of the information into the target format that can be processed by the operation module.

Preferably, the server end also comprises a rule update module, the rule update module is connected with the rule engine module and used to update the target billing rules in the rule engine module according to the marketing strategy.

Preferably, the business module, operation module, financial operation node and rule update module are all connected to a cloud data management platform, the data stored in the cloud data management platform includes but is not limited to user account information, user history order information, user login log, operator business type and target billing rules; in addition, the cloud data management platform is controlled by the back-end administrator, so that the administrator can update the working mode of the business module, operation module, financial operation node and rule update module in the cloud distribution platform system based on the cloud data management platform.

Preferably, the financial operation node is connected with a third-party funding platform, and is used to deduct fees from the third-party funding platform if the requirements are met.

Preferably, the client end comprises an interactive module and a display unit, wherein the interactive module is connected with the third-party funding platform, business module and operation module for obtaining business information, placing orders, and paving order fees; the display unit is used for displaying business information, order information and payment information.

Preferably, the client end also comprises a security management module, the security management module is connected with interactive module, and is used to encrypt the user's order information to protect the user's privacy.

Preferably, the encryption processing process performed by the security management module on the user's order information comprises:
step S1: the user selects what he needs from the business types provided by the business module, and the client end generates order information from this:
step S2: the security management module sends the key negotiation request to the business module, and the security management module generates the corresponding public key and private key, wherein the private key is used for the encryption of the order information by the security management module, and the public key is used for the decryption of the order information by the business module,
step S3: the security management module uses the private key to encrypt the summary information of the order information to obtain the digital signature information;
step S4: the security management module continues to encrypt the digital signature information and the order information asymmetrically to generate the order package;
step S5: the security management module sends the order package to the business module;
step S6: the business module decrypts the order package with the public key to get the order information of the user.

Preferably, the security management module is also connected with the feedback module, and the third-party funding platform is also provided with a security platform, the security platform is connected with the security management module to compare the security information provided by the feedback module and the security management module to ensure the security of the payment process.

Preferably, the security platform guarantees the security of the payment process through the following steps:
step S1: the operation module generates a unique identification number while generating billing information according to the business request;
step S2: the operation module sends the billing information and the unique identification number to the feedback module and the financial operation node respectively;
step S3: the feedback module sends the billing information and the unique identification number to the security management module;
step S4: after the user verifies that the billing information is correct, enter the payment password, and the security management module sends the payment password and unique identification number to the third-party funding platform;
step S5: the financial operation node sends the unique identification number to the security platform;
step S6: when the security platform verifies that the unique identification numbers in step S4 and step S5 are the same, and the payment password is correct, it authorizes the financial operation node to deduct funds from the third-party funding platform.

The B2B-based cloud distribution platform system provided by the present invention is particularly suitable for travel product providers, can save enterprise program development costs, and protect user privacy and fund security.

### BRIEF DESCRIPTION OF THE DRAWINGS

FIG. 1 is a system architecture diagram of the B2B-based cloud distribution platform system of the present invention.

### DETAILED DESCRIPTION OF SOME EMBODIMENTS

In order to have a better understanding of the technical solutions and beneficial effects of the present invention, the technical solutions of the present invention and the beneficial effects produced will be described in detail below with reference to the accompanying drawings.

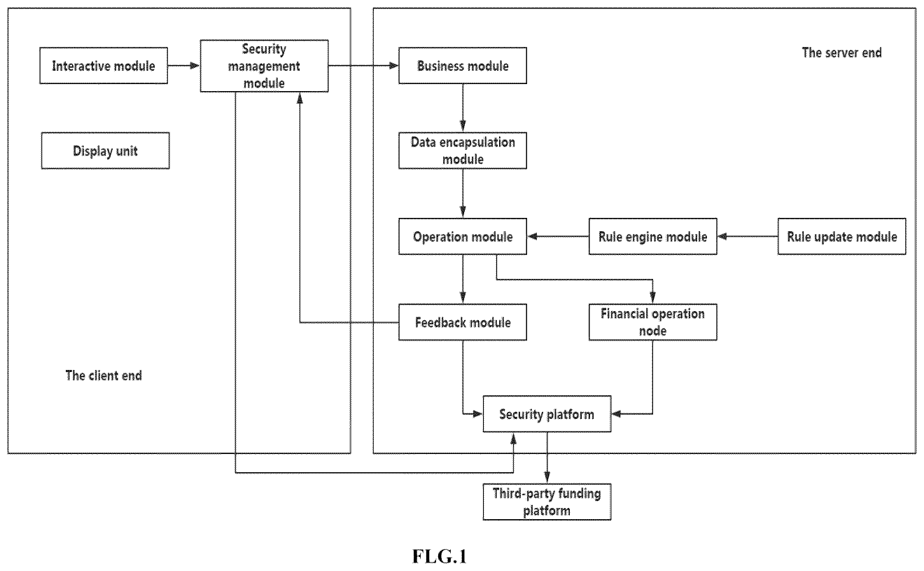

FIG. 1 is the system architecture diagram of the B2B-based cloud distribution platform system provided by the present invention, as shown in FIG. 1, the B2B-based cloud distribution platform system provided by the present invention, comprising a client end and a server end, wherein the server end comprises a business module, a data encapsulation module, an operation module, a rule engine module, a rule update module, a feedback module and a financial operation node, the client end comprises a display unit, an interactive module and a security management module, both the client end and server end are connected with a third-party funding platform.

### 1. The Server End

The business module is used to display and provide the business and business fee information that the distribution platform can provide to the client end, and at the same time accept the customer's order information: the relevant business and business fee information includes but is not limited to the various services and service fees that the distribution platform can provide, for the tourism platform, such information may include the tourist routes, tour dates, travel costs, hotel details, hotel rates and chartered bus fees, etc.

The data encapsulation module is connected with the business module and the operation module, and is used to accept the user order information provided by the business module and convert the corresponding data format of the information into the target format that can be processed by the operation module.

The operation module is connected with the data encapsulation module and the rule engine module, the rule engine module provides target billing rules to the operation module for the operation module to generate billing information based on the billing rules and the order information provided by the data encapsulation module, the rule update module is used to update the target billing rule in the rule engine module according to the marketing strategy.

The billing rules in the rule engine module can be stored in the module in the form of scripts, for travel products, travel platforms and hotels will provide some corresponding preferential measures in conjunction with holidays, therefore the billing rules need to be changed periodically. Existing the billing rules in the form of scripts can avoid the shortcomings caused by traditional hard coding, in the case of changes to the billing rules, it can take effect immediately in the online environment without restarting the calculator, saving the company's program development costs.

The feedback module is connected with the operation module and the client end, and is used to feedback the billing information generated by the operation module to the client end for customers to confirm.

The financial operation node is connected with the feedback module, the operation module and the third-party funding platform, and is used to perform deduction operations based on the billing information generated by the operation module, and feedback the payment success information to the client through the feedback module.

### 2. The Client End

The client end mainly includes three modules: interactive module, display unit and security management module; the interactive module is used to realize the interaction between the user and the distribution platform, which can be the keyboard and mouse on the PC side, or the touch screen of the smart mobile terminal, etc. The interaction module is also connected with the third-party funding platform through the security management module, and is used to send a payment password to the third-party funding platform for the financial operation node to deduct fees from the third-party funding platform. The display unit is connected with the server end, specifically connected with the service module, operation module and feedback module of the server end, and is used to display the business information provided by the distribution platform, the billing information to be confirmed generated after the user places an order, and the result information of deductions etc.

The security management module is the original functional module of the present invention, on the one hand, it is connected to the interaction module and the business module, and is used to encrypt the user's order information to prevent information from being stolen during the interaction process, protect the user's privacy, and prevent users from being interfered by advertisements in the future; on the other hand, the security management module is connected with the third-party funding platform and the feedback module to provide another layer of security in the case of password payment to ensure the safety of user funds.

A specific implementation process for the security management module to protect the user's order information is completed by the following steps:
step S1: the user selects what he needs from the business types provided by the business module, and the client end generates order information from this;
step S2: the security management module sends the key negotiation request to the business module, and the security management module generates the corresponding public key and private key, wherein the private key is used for the encryption of the order information by the security management module, and the public key is used for the decryption of the order information by the business module;
step S3: the security management module uses the private key to encrypt the summary information of the order information to obtain the digital signature information;
step S4: the security management module continues to encrypt the digital signature information and the order information asymmetrically to generate the order package;
step S5: the security management module sends the order package to the business module;
step S6 the business module decrypts the order package with the public key to get the order information of the user.

The realization process of the security management module providing another layer of security guarantee for the safety of users' funds is realized through cooperation with the security platform, operation module and feedback module, a specific realization process is as follows:
step S1: the operation module generates a unique identification number while generating billing information according to the business request;
step S2: the operation module sends the billing information and the unique identification number to the feedback module and the financial operation node respectively;
step S3: the feedback module sends the billing information and the unique identification number to the security management module;
step S4: after the user verifies that the bill information is correct, enter the payment password, and the security management module sends the payment password and unique identification number to the third-party funding platform;
step S5: the financial operation node sends the unique identification number to the security platform;
step S6: when the security platform verifies that the unique identification numbers in step S4 and step S5 are the same, and the payment password is correct, it authorizes the financial operation node to deduct funds from the third-party funding platform.

In the present invention, the security platform can be built on the server end, after the payment security is verified on the server end, the financial operation node directly deducts fees from the third-party funding platform, or the security platform can also be built on the third-party funding platform, wherein the distribution platform and the third-party funding platform agree on a cooperation strategy in advance, and the third-party funding platform can perform a simple function improvement for the distribution platform of the present invention, the architecture method of the security platform in the third-party funding platform can be selected from any existing technology, its function is limited to comparing two unique identification numbers, if the unique identification numbers are the same, it will feed back payment information to the third-party funding platform, and if the unique identification numbers are inconsistent, it will feed back the payment unsuccessful information to the security management module, this technology is what is achievable in the prior art, the present invention will not be repeated.

In the invention, the business module, operation module, financial operation node and rule update module are all connected with a cloud data management platform, the data stored in the cloud data management platform includes but is not limited to user account information, user history order information, user login log, operator business type and target billing rules; in addition, the cloud data management platform is controlled by the back-end administrator, so that the administrator can update the working mode of the business module, operation module, rule engine module, financial operation node and feedback module in the cloud distribution platform system based on the cloud data management platform.

The beneficial effects of the present invention are as follows:
1. Through the setting of the rule update module, the present invention can be specifically applied to some travel platforms that often choose discount promotion activities according to holidays, etc., and is especially suitable for travel product providers.
2. Through the setting of the rule update module, multi-channel procurement and distribution can also be realized. The supplier system calls the interface module for resource release, after the system calculates through the business rule update module, the product is distributed to the major distribution platforms through the interface. The distribution platform orders are seamlessly connected to the supplier platform. In this way, the supply side, the platform side, and the distribution side can be realized.
3. Through the setting of the rule engine module and its script form, the defects caused by traditional hard coding can be avoided, in the case of changes to the billing rules, it will take effect immediately in the online environment without restarting the calculator, saving the company's procedures Development costs.
4. Through the setting of the security management module and the cooperation between the security management module and the server and third-party funding platforms, on the one hand, the privacy of users is protected, and on the other hand, the security of users' funds is protected.

Although the present invention has been described using the above-mentioned preferred embodiments, it is not intended to limit the scope of protection of the present invention, anyone skilled in the art can make various changes and modifications to the above-mentioned embodiments without departing from the spirit and scope of the present invention, and that still belong to the scope of protection of the present invention, so the protection scope of the present invention is defined by the claims.

1. A B2B-based cloud distribution platform system, wherein it comprises: a client end and a server end, in which
the server end comprises:
a business module, which is used to display and provide the client end with the business and business fee information that the distribution platform can provide, and at the same time accept the order information of the customer;
an operation module, which is connected with business module, used to receive order information and generate bills;
a feedback module, which is connected with the operation module and the client, is used to feedback the billing information generated by the operation module to the client end for the customer's confirmation; and
a financial operation node, which is connected with the feedback module and the operation module to deduct the payment according to the billing information generated by the operation module, and feedback the payment success information to the client end through the feedback module.

2. The B2B-based cloud distribution platform system of claim 1, wherein the server end also comprises a rule engine module and a data encapsulation module, the rule engine module is connected with the operation module to provide the operation module with target billing rules for the operation module to generate billing information; and
the data encapsulation module is connected with the business module and the operation module, and is used to accept the user order information provided by the business module, and convert the corresponding data format of the information into the target format that can be processed by the operation module.

3. The B2B-based cloud distribution platform system of claim 2, wherein the server end also comprises a rule update module, the rule update module is connected with the rule engine module and used to update the target billing rules in the rule engine module according to the marketing strategy.

4. The B2B-based cloud distribution platform system of claim 3, wherein the business module, operation module, financial operation node and rule update module are all connected to a cloud data management platform, the data stored in the cloud data management platform includes but is not limited to user account information, user history order information, user login log, operator business type and target billing rules; in addition, the cloud data management platform is controlled by the back-end administrator, so that the administrator can update the working mode of the business module, operation module, financial operation node and rule update module in the cloud distribution platform system based on the cloud data management platform.

5. The B2B-based cloud distribution platform system of claim 5, wherein the financial operation node is connected with a third-party funding platform, and is used to deduct fees from the third-party funding platform if the requirements are met.

6. The B2B-based cloud distribution platform system of claim 5, wherein the client end comprises an interactive module and a display unit, wherein the interactive module is connected with the third-party funding platform, business module and operation module for obtaining business information, placing orders, and paying order fees; the display unit is used for displaying business information, order information and payment information.

7. The B2B-based cloud distribution platform system of claim 6, wherein the client end also comprises a security management module, the security management module is connected with interactive module, and is used to encrypt the user's order information to protect the user's privacy.

8. The B2B-based cloud distribution platform system of claim 7, wherein the encryption processing process performed by the security management module on the user's order information comprises:
step S1: the user selects what he needs from the business types provided by the business module, and the client end generates order information from this;
step S2: the security management module sends the key negotiation request to the business module, and the security management module generates the corresponding public key and private key, wherein the private key is used for the encryption of the order information by the security management module, and the public key is used for the decryption of the order information by the business module.
step S3: the security management module uses the private key to encrypt the summary information of the order information to obtain the digital signature information;
step S4: the security management module continues to encrypt the digital signature information and the order information asymmetrically to generate the order package;
step S5: the security management module sends the order package to the business module;
step S6: the business module decrypts the order package with the public key to get the order information of the user.

9. The B2B-based cloud distribution platform system of claim 7, wherein the security management module is also connected with the feedback module, and the third-party funding platform is also provided with a security platform, the security platform is connected with the security management module to compare the security information provided by the feedback module and the security management module to ensure the security of the payment process.

10. The B2B-based cloud distribution platform system of claim 9, wherein the security platform guarantees the security of the payment process through the following steps:
step S1: the operation module generates a unique identification number while generating billing information according to the business request;
step S2: the operation module sends the billing information and the unique identification number to the feedback module and the financial operation node respectively;
step S3: the feedback module sends the billing information and the unique identification number to the security management module;
step S4: after the user verifies that the billing information is correct, enter the payment password, and the security management module sends the payment password and unique identification number to the third-party funding platform;
step S5: the financial operation node sends the unique identification number to the security platform;
step S6 when the security platform verifies that the unique identification numbers in step S4 and step S5 are the same, and the payment password is correct, it authorizes the financial operation node to deduct funds from the third-party funding platform.
